(19) United States
(12) Patent Application Publication
(10) Pub. No.: US 2017/0083095 A1
(43) Pub. Date: Mar. 23, 2017

(54) SENSOR INTEGRATED HAPTIC DEVICE AND METHOD FOR MANUFACTURING THE SAME

(71) Applicant: Soongsil University Research Consortium Techno-Park, Seoul (KR)

(72) Inventors: Hojin Lee, Seoul (KR); Do Hwan Kim, Anyang-si (KR); Eun Ah Heo, Incheon (KR); Sang Sik Park, Seoul (KR)

(21) Appl. No.: 15/145,868

(22) Filed: May 4, 2016

(30) Foreign Application Priority Data
Sep. 23, 2015 (KR) 10-2015-0134568

(51) Int. Cl. G06F 3/01; G06F 3/044

(52) U.S. Cl. CPC G06F 3/016; G06F 3/044; G06F 2203/04103

(57) ABSTRACT

A sensor integrated haptic device, a method for manufacturing the sensor integrated haptic device and an electronic device including the sensor integrated haptic device are provided. To elaborate, the sensor integrated haptic device includes a sensor and an actuator formed to be arranged on the same plane as the sensor, and each of the sensor and the actuator includes a lower electrode formed through a first process, an ionic elastomer layer formed on the lower electrode through a second process, and an upper electrode formed on the ionic elastomer layer through a third process.

### CROSS-REFERENCE TO RELATED APPLICATION

This application claims the benefit under 35 USC 119(a) of Korean Patent Application No. 10-2015-0134568 filed on Sep. 23, 2015, in the Korean Intellectual Property Office, the entire disclosure of which is incorporated herein by reference for all purposes.

### BACKGROUND

The present disclosure relates to an ionic elastomer-based sensor integrated haptic device and a method for manufacturing the same.

Recently, according to the needs of users wanting to easily use electronic devices, touch input type devices have been generalized. Among the touch input type devices, a haptic feedback device provides feedback of a touch and thus provides a more intuitive experience to a user. Such a haptic feedback device facilitates space saving, convenience in manipulation, easy recognition by a user, and interworking with IT devices.

There has been known a method of using a piezoelectric element as a material for implementing the haptic feedback device. As piezoelectric materials constituting the piezoelectric element, piezoelectric ceramic and a piezoelectric film have been known. Generally, piezoelectric ceramic has a high stiffness and thus has been used as an actuator, and a piezoelectric film has high sensitivity and flexibility and thus has been used as a sensor. However, the piezoelectric materials cannot provide adequate force and displacement in a low frequency range, and the piezoelectric materials in a single unit provide very small force and displacement. Therefore, it is difficult to use the piezoelectric materials as an actuator.

In this regard, there have been disclosed techniques such as Korean Patent Laid-open Publication No. 2011-0077637 (entitled “Piezoelectric actuator actuating haptic device”).

Conventionally, various devices have been used in order to implement various sensors such as a touch sensor, a pressure sensor, and a temperature sensor and actuators capable of providing feedback of tactile sensation. Accordingly, there is an increase in cost due to a complicated process and there is also a limit to durability of the haptic feedback device. Such demerits affect the process cost and yield when a touch sensor is integrated with a display panel or a cover glass in order to minimize a display. Further, even when a sensor and an actuator are configured as separate layers in order to implement various functions, the process cost may be increased and a thickness of a display panel may be gradually increased.

### BRIEF SUMMARY

Some exemplary embodiments of the present disclosure provide an ionic elastomer-based haptic device in which a sensor and an actuator are integrated with each other, and a method for manufacturing the same.

However, problems to be solved by the present disclosure are not limited to the above-described problems. There may be other problems to be solved by the present disclosure.

In accordance with an exemplary embodiment of the present disclosure, there is provided a sensor integrated haptic device. The device may include a sensor; and an actuator formed to be arranged on the same plane as the sensor. Herein, each of the sensor and the actuator may include a lower electrode formed through a first process, an ionic elastomer layer formed on the lower electrode through a second process, and an upper electrode formed on the ionic elastomer layer through a third process.

Further, in accordance with another exemplary embodiment of the present disclosure, there is provided a method for manufacturing a sensor integrated haptic device. The method may include: forming lower electrodes of a sensor and an actuator in a predetermined sensor region and a predetermined actuator region, respectively, on a substrate; stacking ionic elastomer layers on the lower electrodes; and forming upper electrodes on the ionic elastomer layers. Herein, the sensor region is arranged to be adjacent to at least a part of the actuator region or surround the circumference of the actuator.

In accordance with yet another exemplary embodiment of the present disclosure, there is provided an electronic device including a sensor integrated haptic device. The electronic device may include: multiple sensor integrated haptic devices each including a sensor and an actuator formed to be arranged on the same plane as the sensor; a power supply line configured to supply power to each actuator; and a transmission line configured to transmit a sensing voltage to each sensor. Herein, each of the sensor and the actuator may include a lower electrode formed through a first process, an ionic elastomer layer formed on the lower electrode through a second process, and an upper electrode formed on the ionic elastomer layer through a third process.

According to the above-described exemplary embodiment of the present disclosure, a sensor integrated haptic device can sense an external environment and provide mechanical feedback at the same time, and can also be easily manufactured in the form of an array. Therefore, the sensor integrated haptic device can be conveniently applied to various application fields such as a touch panel of a display.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1A is a schematic diagram of a sensor integrated haptic device in accordance with an exemplary embodiment of the present disclosure.

FIG. 1B is a cross-sectional view of the sensor integrated haptic device in accordance with the exemplary embodiment of the present disclosure.

FIG. 2 is a schematic diagram of a sensor integrated haptic device in accordance with another exemplary embodiment of the present disclosure.

FIG. 3A-3D is a diagram provided to explain an actuating principle of actuator in a sensor integrated haptic device in accordance with an exemplary embodiment of the present disclosure.

FIG. 4A-4F is a diagram provided to explain a method for manufacturing a sensor integrated haptic device in accordance with an exemplary embodiment of the present disclosure.

FIG. 5 is a flowchart provided to explain a method for manufacturing a sensor integrated haptic device in accordance with an exemplary embodiment of the present disclosure.

FIG. 6 illustrates an array structure of a sensor integrated haptic device in accordance with an exemplary embodiment of the present disclosure.

FIG. 7 illustrates an array structure of a sensor integrated haptic device in accordance with another exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Hereinafter, a sensor integrated haptic device in accordance with exemplary embodiments of the present disclosure will be described with reference to the accompanying drawings.

A haptic actuator to be described hereinafter is configured to provide vibration or physical displacement in order to enable a user to feel the vibration or bump through tactile sensation. The haptic actuator includes an ionic elastomer layer having elasticity.

Further, a sensor includes an ionic elastomer layer between electrodes, and is configured to detect a change of a capacitance formed between the electrodes in response to an external pressure.

Furthermore, integration of the sensor with the actuator may mean structural or functional integration, but may not be limited thereto.

A haptic device in accordance with an exemplary embodiment of the present disclosure is implemented with a sensor and an actuator in a single cell by arranging two upper and lower metal layers used as electrodes and an ionic elastomer layer between the two metal layers. Herein, the ionic elastomer layer is an electroactive polymer which is contracted and expanded due to migration and diffusion of ions when an external voltage is applied. Further, the ionic elastomer layer is lightweight and flexible, and has a high response speed and is greatly transformed even at a low voltage. Therefore, if a voltage is applied to both the electrodes of the haptic device, bending deformation occurs. On the contrary, if the haptic device is mechanically transformed under that the external voltage is applied in mV range, a capacitance difference is generated between both the electrodes, and, thus, it can be used as a sensor.

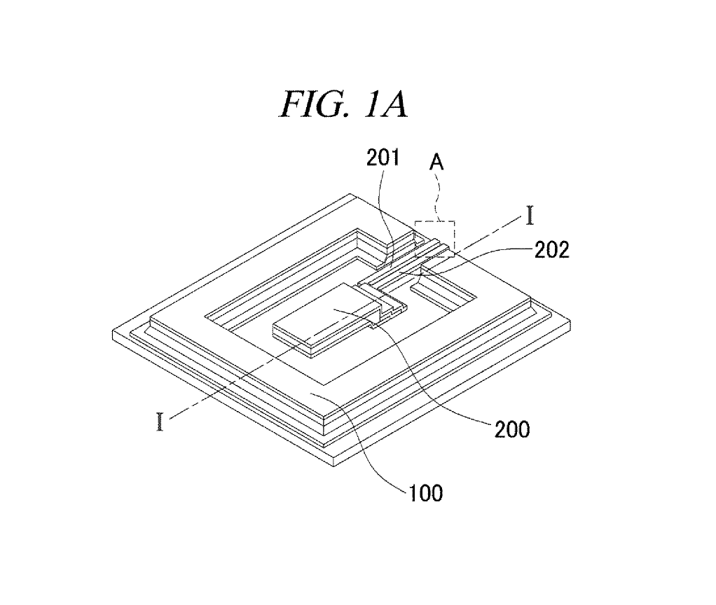

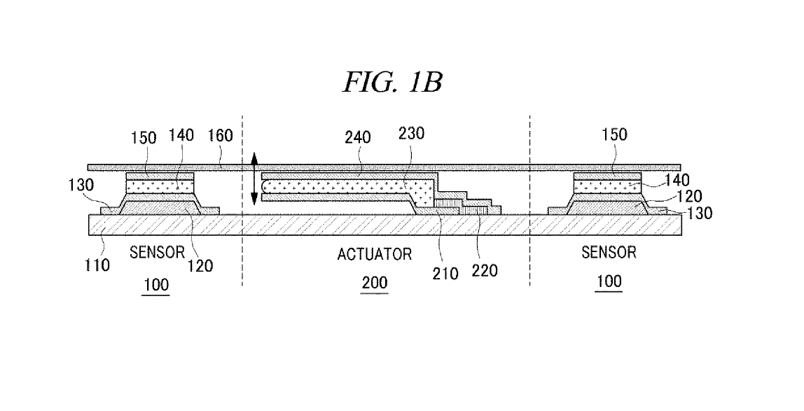

FIG. 1A is a configuration view of a sensor integrated haptic device in accordance with an exemplary embodiment of the present disclosure, and FIG. 1B is a diagram illustrating a cross section of the sensor integrated haptic device taken along a line I-I of FIG. 1A.

Referring to FIG. 1A, the sensor integrated haptic device includes a sensor 100 and an actuator 200. Herein, the sensor 100 may be configured to surround the actuator 200 in order to protect the actuator from an external pressure such as a touch of a user and secure the reliability.

Further, the sensor integrated haptic device further includes a first line 201 connected to an upper electrode of the actuator 200 and a second line 202 connected to a lower electrode of the actuator 200. Herein, the sensor 100 may include an outlet A that enables the first line and the second line to be withdrawn to the outside of the sensor 100.

Herein, a layer of the sensor 100 and a layer of the actuator 200 may be formed together to be arranged on the same plane. Therefore, as illustrated in FIG. 1B, the sensor 100 and the actuator 200 may be formed on a same substrate 110.

The substrate 110 may be formed of any one of glass, ceramic, silicon, and plastic, but may not be limited thereto. Desirably, the substrate 110 may be formed of a material which is not affected by a thin film deposition process or etching process performed while the sensor 100 and the actuator 200 are formed on an upper surface of the substrate 110.

The sensor integrated haptic device may further include an anti-contamination film 160 on upper surfaces of the sensor 100 and actuator 200. Herein, the anti-contamination film 160 may include a thin and flexible polymer film.

A structure of the sensor integrated haptic device will be described in more detail with reference to FIG. 1B.

As illustrated in FIG. 1B, the sensor 100 and the actuator 200 include lower electrodes 130 and 210 formed through a first process, ionic elastomer layers 140 and 230 formed on the lower electrodes 130 and 210 through a second process, and upper electrodes 150 and 240 formed on the ionic elastomer layers 140 and 230 through a third process, respectively.

Although the respective manufacturing processes of the lower electrodes 130 and 210, ionic elastomer layers 140 and 230 and upper electrodes 150 and 240 respectively included in the sensor 100 and the actuator 200 are separately described above for convenience in explanation, they may be manufactured in the same process. By way of example, the lower electrode 130 of the sensor 100 and the lower electrode 210 of the actuator 200 may be manufactured in the same process using the same material.

The sensor 100 may sense various physical quantities such as pressure, temperature, pressure to tactile and humidity or changes thereof. Herein, a structure of the sensor 100 may be formed into various shapes, for example, a polygon, such as a square, hexagon and an octagon, and a circle. That is, a shape of the sensor 100 can be freely modified depending on a device and is not limited in size and shape.

The sensor 100 may further include a sacrificial layer 120. The sacrificial layer 120 may be formed to adjust a height of the sensor 100 to correspond to a height of the actuator 200. In other words, a height of the sensor 100 can be adjusted by adjusting a height of the sacrificial layer 120. Herein, the lower electrode 130 may be formed to surround the sacrificial layer 120.

Further, the sensor integrated haptic device may further include a control unit (not illustrated) configured to detect a capacitance formed between the lower electrode 130 and the upper electrode 150 of the sensor 100 and sense an external pressure according to a variation of the detected capacitance.

In the sensor 100 of the sensor integrated haptic device, when a pressure is applied from the outside, the ionic elastomer layer 140 is transformed and a gap between the electrodes is changed, which results in a change of a capacitance formed between the lower electrode 130 and the upper electrode 150 of the sensor 100.

The actuator 200 is a converter configured to receive a signal and output mechanical power. The actuator 200 can be manufactured through a general MEMS process. In an exemplary embodiment of the present disclosure, the actuator 200 has a cantilever shape supported by the substrate 110, but may not be limited thereto. The actuator 200 can be formed on the same plane, but may have various shapes, such as a bridge or a bar, depending on the design purpose of the device and may not be limited to any one shape or arrangement.

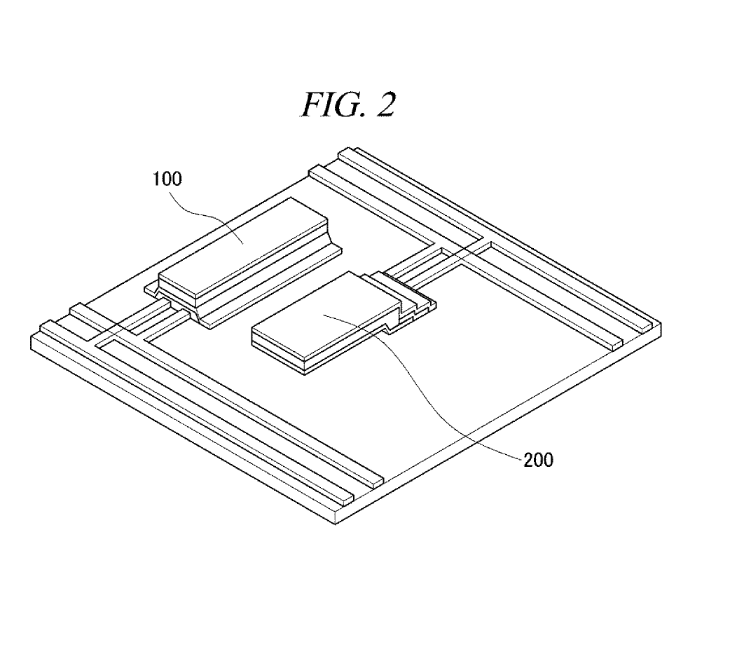

Another example of the sensor integrated haptic device is shown in FIG. 2.

FIG. 2 is a schematic diagram of a sensor integrated haptic device in accordance with another exemplary embodiment of the present disclosure.

As illustrated in FIG. 2, in the sensor integrated haptic device in accordance with another exemplary embodiment of the present disclosure, the sensor 100 and the actuator 200 may be formed to be arranged in parallel with each other. That is, the sensor 100 does not surround the entire actuator 200, but is arranged on one side of the actuator 200. The sensor integrated haptic device according to another exemplary embodiment may be very similar or identical to the sensor integrated haptic device according to an exemplary embodiment of the present disclosure in properties, structures, and manufacturing processes of the respective components except a difference in arrangement of the sensor 100 and the actuator 200 of the sensor integrated haptic device.

Referring to FIB. 1B again, the actuator 200 may be formed of any one of electroactive ceramic (EAC), a shape memory alloy (SMA), an electroactive polymer (EAP), an ionic polymer metal composite (IPMC), and a dielectric polymer.

To be specific, the actuator 200 includes the lower electrode 210, an insulation layer 220 in contact with a predetermined region of the lower electrode 210, the ionic elastomer layer 230 in contact with the insulation layer 220 and formed on an upper surface of the lower electrode 210, and the upper electrode 240 formed on upper surfaces of the ionic elastomer layer 230 and insulation layer 220.

Herein, the predetermined region of the lower electrode 210 may be arranged to be apart from the substrate as much as a thickness of the sacrificial layer 120 by the sacrificial layer 120 formed during a manufacturing process of the sensor integrated haptic device. Then, the lower electrode 210, the insulation layer 230, and the upper electrode 240 are formed in sequence on the sacrificial layer 120. Then, the sacrificial layer 120 may be removed by selective etching. Accordingly, as illustrated in FIG. 1B, the actuator 200 in accordance with an exemplary embodiment of the present disclosure may be implemented into a cantilever structure.

That is, in the sensor 100, the sacrificial layer 120 has a function of adjusting a height of the sensor 100 to correspond to a height of the actuator 200. Further, in the actuator 200, the sacrificial layer 120 may be formed and then removed in order to form a cantilever structure. As a result, the actuator 200 has a cantilever or bridge shape that are respectively supported by one or two self-supporting posts anchored on the substrate 110.

The insulation layer 220 is formed on the lower electrode 210. Herein, the insulation layer 220 has a function of separating the lower electrode 210 and the upper electrode 240 in order to form a potential difference between the lower electrode 210 formed under the insulation layer 220 and the upper electrode 240 formed on the insulation layer 220.

Referring to FIG. 1A and FIG. 1B, the sensor integrated haptic sensor in accordance with an exemplary embodiment of the present disclosure may further include the first line 201 connected to the upper electrode 240 of the actuator 200, the second line 202 connected to the lower electrode 210 of the actuator 200, and the outlet A that enables the first line 201 and the second line 202 to be withdrawn to the outside of the sensor 100. As such, a layer of the sensor 100 and a layer of the actuator 200 may be formed together to be arranged on the same plane. That is, the sensor 100 and the actuator 200 may be formed on the same substrate 110.

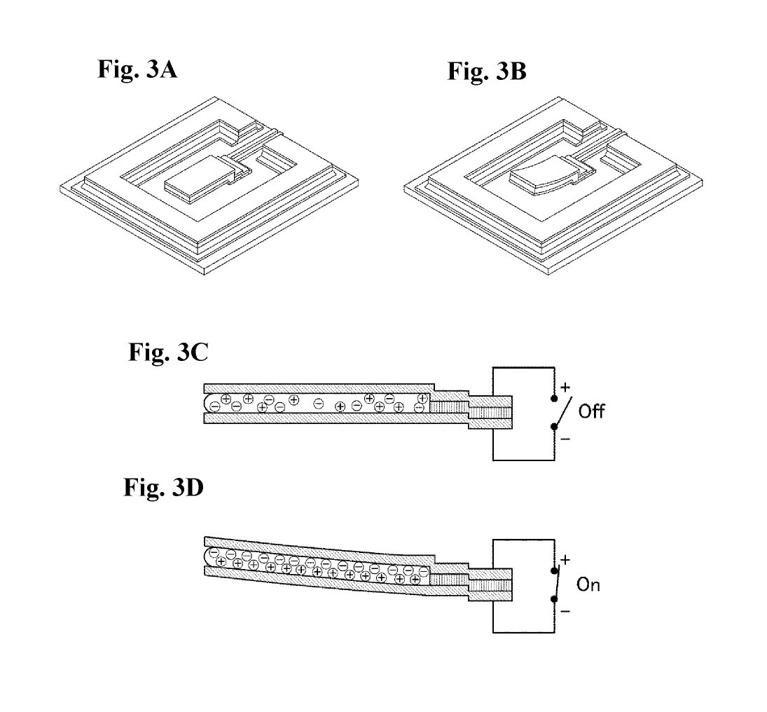

FIG. 3 is a diagram provided to explain an actuating principle of actuator in a sensor integrated haptic device in accordance with an exemplary embodiment of the present disclosure.

Herein, illustrations (a) and (c) of FIG. 3 illustrate an off state in which electricity is off, and illustrations (b) and (d) of FIG. 3 illustrate an on state in which electricity is on.

Referring to illustrations (a) and (c) of FIG. 3, if a voltage is not applied, cations and anions are present within the ionic elastomer layer 230 of the actuator 200. Further, since one side of the actuator 200 is fixed to the substrate, the actuator 200 is not changed in shape.

Meanwhile, referring to illustrations (b) and (d) of FIG. 3, if a voltage is applied, the cations and anions present within the ionic elastomer layer 230 of the actuator 200 migrate toward a negatively or positively charged electrode. Accordingly, the ions within the ionic elastomer layer 230 are separated from each other at an interface between the electrode and the electrodes and thus form an electrical double layer. Therefore, the actuator 200 is bent in a migration direction of electrons.

That is, since the cations and anions present within the ionic elastomer layer 230 migrate toward a negatively or positively charged electrode, the total volume of cations and anions in the lower electrode 210 and the upper electrode 240 is changed. Therefore, a negatively charged electrode layer is expanded and a positively charged electrode layer is contracted, and, thus, bending deformation of the actuator 200 occurs.

Herein, the actuator 200 is greatly bent in response to an electrical stimulus of several volts (V), and causes a change of a capacitance in response to an electrical stimulus of several mV or mechanical deformation (or vibration). Such a phenomenon is caused by a change of a charge amount of the electrical double layer when surplus ions migrate to a surface of the electrode due to bending deformation, such as expansion or contraction, of the ionic elastomer layer 230.

As described above, the sensor 100 and the actuator 200 can be manufactured in a single cell at the same time through a series of processes and can also be manufactured to have a large area. Herein, the actuator 200 in accordance with an exemplary embodiment of the present disclosure can be used by interworking with the sensor 100. Further, the actuator 200 can provide feedback of a realistic tactile impression to a user upon a touch by the user, and can also provide various tactile impressions depending on a voltage (ex. amplitude and frequency of the applied voltage).

By way of example, if the sensor 100 senses a touch by the user, the actuator 200 is activated to provide feedback of the touch. Further, if the number of times and an interval of a pulse voltage input to the actuator 200 are controlled, haptic sensations various in intensity and interval of a tactile impression can be provided to the user. Herein, the number of times and the interval of the pulse may be implemented by analog and digital logic circuits.

In an application example of a tactile display based on the actuator 200 in accordance with the exemplary embodiments of the present disclosure, feedback may be provided at the time of a key click or scrolling on a virtual keyboard. Further, at the time of execution of multi-media or a game, a collision or explosion effect or rhythm of music may be provided. Furthermore, material properties of an object surface such as a surface roughness, a micro pattern, warmth, and a frictional force can be provided. Thus, it is possible to provide various user experiences.

Meanwhile, in the sensor integrated haptic device in accordance with an exemplary embodiment of the present disclosure, if a pressure is applied from the outside, the ionic elastomer layer 140 of the sensor 100 is physically deformed, and, thus, a capacitance value of the sensor 100 is changed accordingly. Therefore, it is possible to detect a change of an external pressure by measuring a change of the capacitance value.

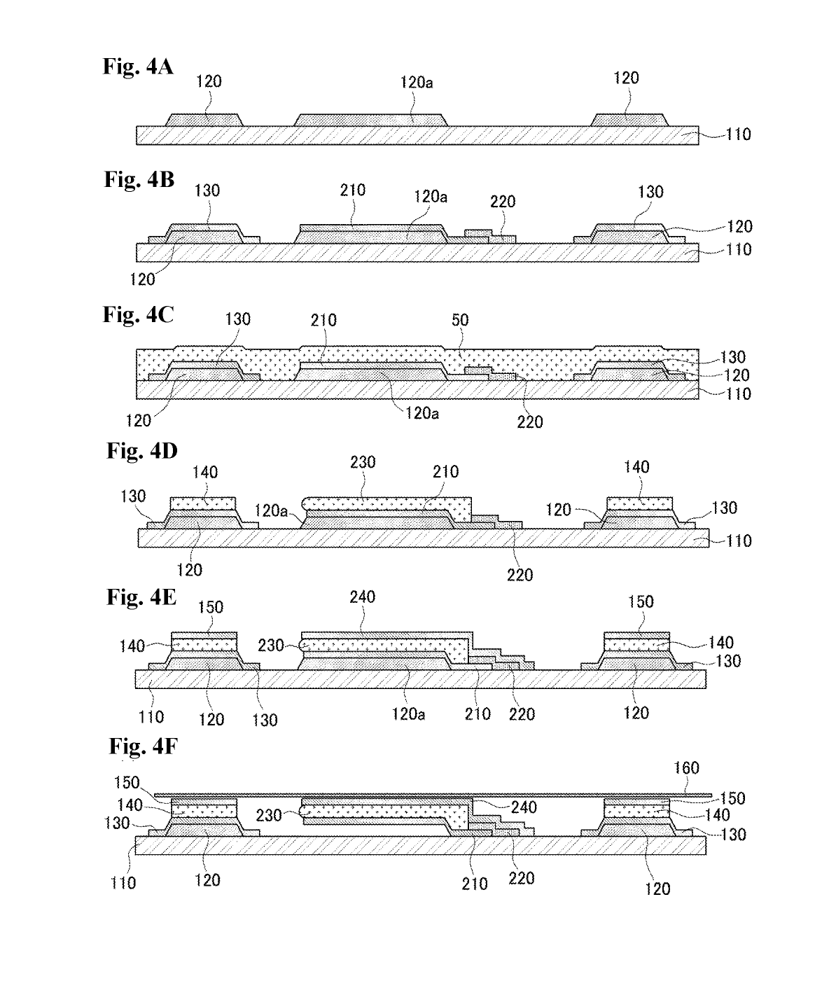

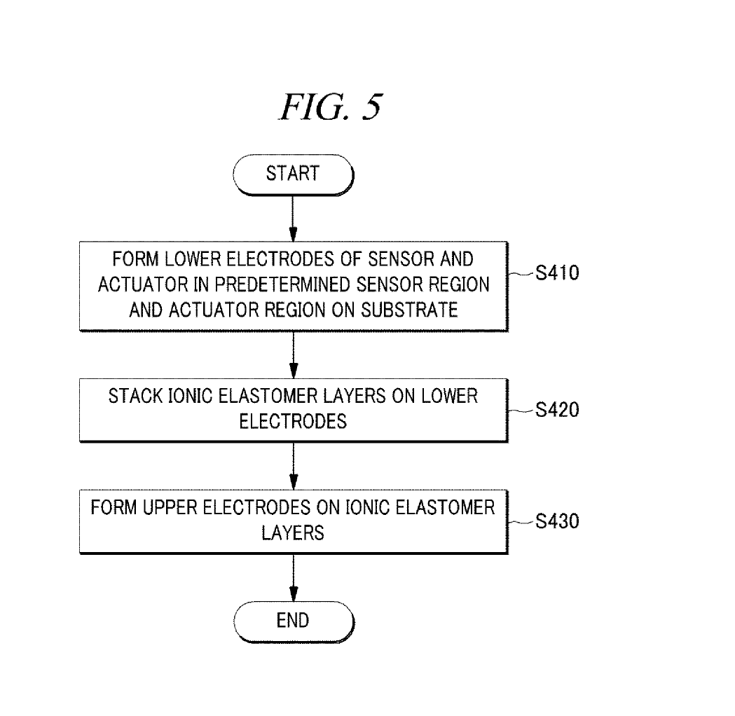

Hereinafter, a method for manufacturing a sensor integrated haptic device in accordance with an exemplary embodiment of the present disclosure will be described in detail with reference to FIG. 4 and FIG. 5.

FIG. 4 is a conceptual diagram illustrating a method for manufacturing a sensor integrated haptic device in accordance with an exemplary embodiment of the present disclosure, and FIG. 5 is a flowchart illustrating a method for manufacturing a sensor integrated haptic device in accordance with another exemplary embodiment of the present disclosure.

The sensor integrated haptic device in accordance with an exemplary embodiment of the present disclosure has merits in that the sensor 100 and the actuator 200 can be driven in a single device and the respective processes for manufacturing the sensor 100 and the actuator 200 can be performed at the same time.

Referring to FIG. 5, the method for manufacturing a sensor integrated haptic device in accordance with another exemplary embodiment of the present disclosure includes the following processes.

The method for manufacturing a sensor integrated haptic device includes: forming the lower electrodes 130 and 210 of the sensor 100 and the actuator 200 in a predetermined region for the sensor 100 and a predetermined region for the actuator 200 on the substrate 110 (S410); stacking the ionic elastomer layers 140 and 230 on the lower electrodes 130 and 210 (S420); and forming the upper electrodes 150 and 240 on the ionic elastomer layers 140 and 230 (S430). Herein, the region for the sensor 100 may be arranged to surround the circumference of the region for the actuator 200.

FIG. 4 more specifically illustrates the processes for forming the respective layers illustrated in FIG. 5.

As shown in illustration (a) of FIG. 4, sacrificial layers 120 and 120a are formed on the substrate 110.

The sacrificial layers 120 and 120a are formed in a region for the sensor 100 and a region for the actuator 200, respectively. Herein, the sacrificial layer 120a formed in the region for the actuator 200 is removed after the process for forming the upper electrode 240. When the sacrificial layers 120 and 120a are formed, a photolithography process generally performed for forming a pattern in a semiconductor process may be used. By way of example, in order to form the sacrificial layers 120 and 120a into a desired shape, a specific portion is exposed using a mask and a pattern is developed. Then, a dry or wet etching process is performed to form the sacrificial layers 120 and 120a.

Then, as shown in illustration (b) of FIG. 4, the lower electrodes 130 and 210 are formed on the sacrificial layers 120 and 120a, respectively.

Herein, the lower electrode 130 positioned in the region for the sensor 100 is formed to cover the sacrificial layer 120 in order for the sacrificial layer 120 not to be exposed to the outside. On the other hand, the lower electrode 210 positioned in the region for the actuator 200 is formed in order for one surface of the sacrificial layer 120 to be exposed to the outside. This is not to remove the sacrificial layer 120 positioned in the region for the sensor 100 when the sacrificial layer 120a positioned in the region for the actuator 200 is removed later by etching.

That is, when the lower electrode 210 in the region for the actuator 200 is formed on the sacrificial layer 120a, one surface of the sacrificial layer 120a is exposed to the outside and one surface of the actuator 200 is fixed to the substrate. Therefore, the lower electrode 210 in the region for the actuator 200 is formed on the sacrificial layer 120a and the substrate close to a non-exposed surface of the sacrificial layer 120a, and the lower electrode 210 formed on the sacrificial layer 120a is connected to the lower electrode 210 formed on the substrate. Then, the sacrificial layer 120a in the region for the actuator 200 is removed, so that the actuator 200 having a cantilever shape is formed.

The above-described processes illustrated in illustrations (a) and (b) of FIG. 4 correspond to the process S410 of FIG. 5. For reference, the process S410 for forming the lower electrodes may further include a process for forming an electrode contact integrated with the lower electrode 210 of the actuator 200 in order to apply a voltage to the actuator 200.

The method for manufacturing the lower electrodes 130 and 210 may use the above-described photolithography process after a material for forming the lower electrodes 130 and 210 is deposited by any one of thermal evaporation, e-beam evaporation, and sputtering, but may not be limited thereto. By way of example, the material for forming the lower electrodes 130 and 210 may be printed or may be formed by spray coating, vacuum filtration, and electric radiation depending on the conditions. Herein, the material for forming the lower electrodes 130 and 210 may be an electrode material selected from metal, conductive metal oxide, conductive polymer, conductive carbon, conductive nanoparticles, and nanoparticles inserted between organic substances or conductive substances.

Then, as shown in illustration (b) of FIG. 4, the insulation layer 220 is formed in one region of the lower electrode 210. Herein, the lower electrode 210, on which the insulation layer 220 is formed, is formed on the substrate 110 close to the non-exposed surface of the sacrificial layer 120a.

Then, as shown in illustration (c) of FIG. 4, the ionic elastomer layers 140 and 230 are stacked on upper surfaces of the lower electrodes 130 and 210 and insulation layer 220. Then, as shown in illustration (d) of FIG. 4, except an ionic elastomer for forming the ionic elastomer layers 140 and 230 on the region for the sensor 100 and the region for the actuator 200, an ionic elastomer formed on the other regions is removed.

The above-described processes illustrated in illustrations (c) and (d) of FIG. 4 correspond to the process S420 of FIG. 5. Hereinafter, these processes will be described in more detail.

Firstly, as shown in illustration (c) of FIG. 4, an ionic elastomer 50 for forming the ionic elastomer layers 140 and 230 is formed on the substrate 110 on which the lower electrodes 130 and 210 and the insulation layer 220 are formed.

The ionic elastomer 50 for forming the ionic elastomer layers 140 and 230 may be a mixture of an ionic liquid and a polymer. Herein, the ionic liquid is a salt present in the form of a liquid at room temperature and composed of ions only. Therefore, the ionic liquid has a high conductivity of about 10 mS/cm, a wide potential window of 4 V or more, and a very low volatility. The viscosity of the ionic liquid is similar to that of water. Further, the polymer may be, for example, polyurethane (TPU). The polyurethane (TPU) is transparent and elastic and easily blended with the ionic liquid, and also has a high ionic conductivity. Therefore, the ionic elastomer layers 140 and 230 formed of the ionic liquid and the polymer have high ionic conductivity and elasticity.

Then, as shown in illustration (d) of FIG. 4, except the ionic elastomer 50 to be formed as the ionic elastomer layers 140 and 230 on the region for the sensor 100 and the region for the actuator 200, the ionic elastomer 50 formed on the other regions is removed.

Accordingly, the ionic elastomer layers 140 and 230 are separately formed to perform their functions in the sensor 100 and the actuator 200, respectively. Herein, as a process for separating the ionic elastomer layers 140 and 230, a photolithography process, such as a dry or wet etching process, performed in a semiconductor process may be employed. The process for separating the ionic elastomer layers 140 and 230 is not limited to the above-described method, and a molding method or the like may be employed.

Then, as shown in illustration (e) of FIG. 4, the upper electrodes 150 and 240 are formed on the ionic elastomer layers 140 and 230. A method for forming the upper electrodes 150 and 240 may be the same as the above-described method for forming the lower electrodes 130 and 210. Further, after the upper electrodes 150 and 240 are formed, the sacrificial layer 120a formed in the region for the actuator 200 is removed, so that the device may be completely manufactured.

The process illustrated in illustration (e) of FIG. 4 corresponds to the process S430 of FIG. 5.

For reference, the process S430 for forming the upper electrodes 150 and 240 may further include a process for forming an electrode contact integrated with the upper electrode 240 of the actuator 200.

Meanwhile, after the sensor 100 and the actuator 200 are formed through the above-described processes, a process for forming the anti-contamination film 160 for protecting the sensor 100 and the actuator 200 from external contaminants may be further performed as shown in illustration (f) of FIG. 4.

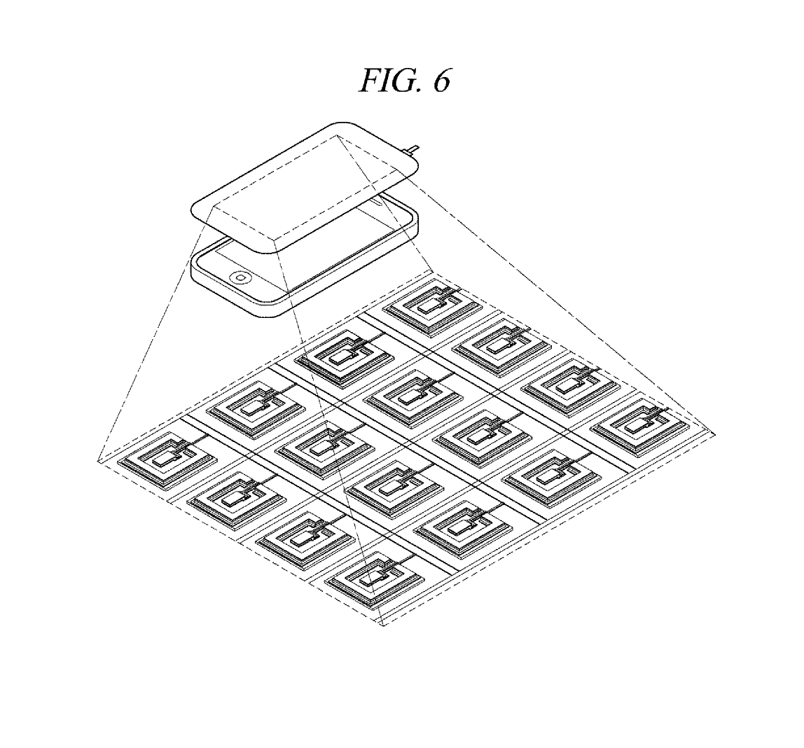

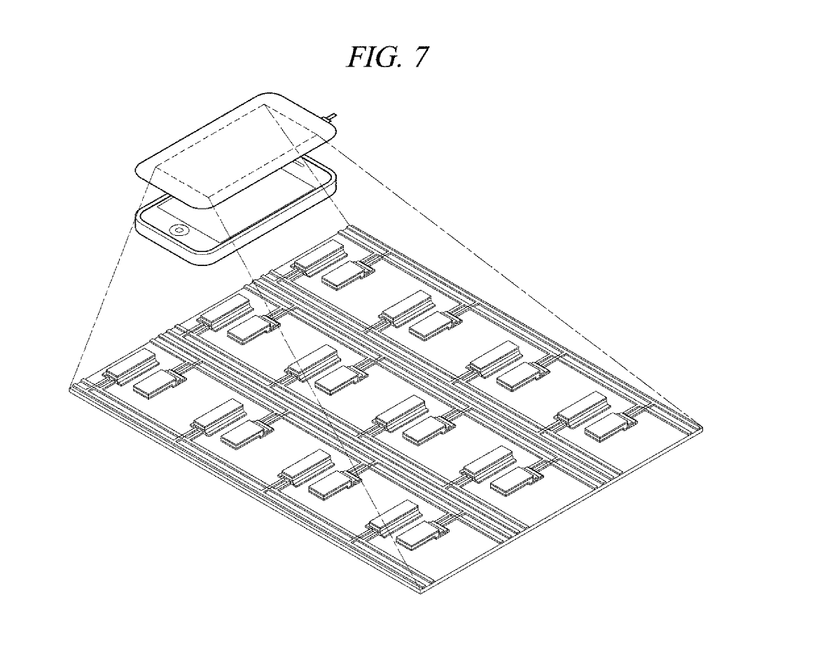

Hereinafter, an electronic device (i.e., a sensor integrated haptic device having an array structure) implemented by arranging multiple sensor integrated haptic devices according to the exemplary embodiments of the present disclosure will be described in detail with reference to FIG. 6 and FIG. 7.

FIG. 6 is a diagram illustrating an array structure of a sensor integrated haptic device in accordance with an exemplary embodiment of the present disclosure, and FIG. 7 is a diagram illustrating an array structure of a sensor integrated haptic device in accordance with another exemplary embodiment of the present disclosure.

In each of the electronic devices in which multiple sensor integrated haptic devices are arranged in an array structure as illustrated in FIG. 6 and FIG. 7, the sensor integrated haptic devices illustrated in FIG. 1 to FIG. 5 are arranged. The electronic device may sense a multi-touch by a user and provide a tactile impression.

To be specific, each of the sensor integrated haptic devices included in the electronic device includes the sensor 100 and the actuator 200 formed to be arranged on the same plane as the sensor 100. Herein, the sensor 100 and the actuator 200 include the lower electrodes 130 and 210 formed through the first process, the ionic elastomer layers 140 and 230 formed on the lower electrodes 130 and 210 through the second process, and the upper electrodes 150 and 240 formed on the ionic elastomer layers 140 and 230 through the third process, respectively. Further, the electronic device includes a power supply line configured to supply power to each actuator 200 and a transmission line configured to transmit a sensing voltage to each sensor 100.

For reference, the multiple sensor integrated haptic devices included in the electronic device may include a passive element and an active element which may be used in a thin film transistor. Herein, the passive element may be manufactured by forming a thin film on a substrate having a good insulating property by deposition or sputtering. By way of example, if a flexible device is used as a substrate in a thin film transistor, the thin film transistor includes a gate electrode, a semiconductor layer, a source electrode, and a drain electrode formed on the flexible device.

Further, if the multiple sensor integrated haptic devices are arranged in an array structure as shown in FIG. 6 and FIG. 7, each of the devices may be integrated with a switching device. Therefore, it is possible to control activation or inactivation of a specific device through the switching device.

The sensor integrated haptic device in accordance with the above-described exemplary embodiments of the present disclosure can be manufactured by arranging the multi-sensor 100 together with the actuator 200 in a single cell on a display panel. Therefore, it is possible to reduce a thickness of a panel also possible to facilitate implementation of detailed sensing and tactile sensation. Further, it is possible to reduce cost due to a simple process. Accordingly, the sensor integrated haptic device can be favorably applied to various fields.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner.

Likewise, components described to be distributed can be implemented in a combined manner.

The scope of the present disclosure is defined by the following claims rather than by the detailed description of the embodiments. It shall be understood that all modifications and embodiments conceived from the meaning and scope of the claims and their equivalents are included in the scope of the present disclosure.

We claim:

1. A sensor integrated haptic device, comprising:
a sensor; and
an actuator formed to be arranged on a same plane as the sensor,
wherein each of the sensor and the actuator includes a lower electrode formed through a first process, an ionic elastomer layer formed on the lower electrode through a second process, and an upper electrode formed on the ionic elastomer layer through a third process.

2. The sensor integrated haptic device of claim 1, further comprising:
a substrate in contact with the sensor and the actuator.

3. The sensor integrated haptic device of claim 1,
wherein the sensor is formed to surround a circumference of the actuator.

4. The sensor integrated haptic device of claim 1,
wherein the sensor is formed to be arranged close to one side surface of the actuator.

5. The sensor integrated haptic device of claim 1,
wherein the actuator has one of a cantilever shape supported by one self-supporting post anchored on the substrate and a bridge shape supported by two self-supporting posts anchored on the substrate.

6. The sensor integrated haptic device of claim 1, further comprising:
a first line connected to the upper electrode of the actuator; and
a second line connected to the lower electrode of the actuator,
wherein the sensor is configured to surround a circumference of the actuator and includes an outlet that enables the first line and the second line to be withdrawn to the outside of the sensor.

7. The sensor integrated haptic device of claim 1, further comprising:
an anti-contamination film on an upper surface of the sensor and an upper surface of the actuator.

8. The sensor integrated haptic device of claim 1,
wherein the sensor further includes:
a sacrificial layer formed through a process performed prior to the first process, and
the lower electrode surrounds the sacrificial layer, the ionic elastomer layer is arranged on an upper surface of the lower electrode, and the upper electrode is arranged on an upper surface of the ionic elastomer layer.

9. The sensor integrated haptic device of claim 8, further comprising:
a control unit configured to detect a capacitance formed between the lower electrode and the upper electrode of the sensor and sense an external pressure based on the capacitance.

10. The sensor integrated haptic device of claim 1,
wherein the actuator further includes an insulation layer in contact with a predetermined region of the lower electrode,
the ionic elastomer layer is in contact with the insulation layer and formed on an upper surface of the lower electrode,
the upper electrode is formed on an upper surface of the ionic elastomer layer and an upper surface of the insulation layer,
the predetermined region of the lower electrode is arranged to be apart from the plane as much as a thickness of a sacrificial layer by the sacrificial layer, and
the sacrificial layer is formed through a process performed prior to the first process and removed from a region for the actuator by selective etching after the upper electrode is formed.

11. The sensor integrated haptic device of claim 1,
wherein the sensor senses at least one of pressure, temperature, and pressure to tactile.

12. The sensor integrated haptic device of claim 1,
wherein the actuator is formed of at least one of piezoceramic, a shape memory alloy, an electroactive polymer, an ionic polymer metal composite, and a dielectric polymer.

13. A method for manufacturing a sensor integrated haptic device, comprising:
forming lower electrodes of a sensor and an actuator in a predetermined sensor region and a predetermined actuator region, respectively, on a substrate;
stacking ionic elastomer layers on the lower electrodes; and
forming upper electrodes on the ionic elastomer layers,
wherein the sensor region is arranged to be adjacent to at least a part of the actuator region or surround a circumference of the actuator.

14. The method for manufacturing a sensor integrated haptic device of claim 13,
wherein the step of forming lower electrodes includes:
forming a sacrificial layer in the sensor region and the actuator region;
forming cantilever or bridge-shaped lower electrodes on a region of an upper surface of the substrate adjacent to the sacrificial layer formed in the actuator region and on an upper surface of the sacrificial layer formed in the actuator region; and
forming an electrode contact integrated with the lower electrode of the actuator, and
the step of forming upper electrodes further includes:
forming an electrode contact integrated with the upper electrode of the actuator.

15. The method for manufacturing a sensor integrated haptic device of claim 14, further comprising:
removing the sacrificial layer from the actuator region after the step of forming upper electrodes.

16. The method for manufacturing a sensor integrated haptic device of claim 13,
wherein the step of stacking ionic elastomer layers on the lower electrodes includes:
stacking an ionic elastomer on upper surfaces of the substrate, the lower electrode of the sensor, and the lower electrode of the actuator; and
removing the ionic elastomer except the ionic elastomer positioned on the upper surface of the lower electrode of the sensor and the upper surface of the lower electrode of the actuator.

17. An electronic device including a sensor integrated haptic device, comprising:
multiple sensor integrated haptic devices each including a sensor and an actuator formed to be arranged on a same plane as the sensor;
a power supply line configured to supply power to each actuator; and
a transmission line configured to transmit a sensing voltage to each sensor,
wherein each of the sensor and the actuator includes a lower electrode formed through a first process, an ionic elastomer layer formed on the lower electrode through a second process, and an upper electrode formed on the ionic elastomer layer through a third process.

18. The electronic device of claim 17,
wherein the sensor is formed to surround a circumference of the actuator.

19. The electronic device of claim 17,
wherein the sensor is formed to be arranged close to one side surface of the actuator.

20. The electronic device of claim 17,
wherein the actuator has one of a cantilever shape supported by one self-supporting post anchored on the substrate and a bridge-shape supported by two self-supporting posts anchored on the substrate.
